(19) United States
(12) Patent Application Publication
(10) Pub. No.: US 2026/0213091 A1
(43) Pub. Date: Jul. 23, 2026

(54) BUTTON STRUCTURE AND ELECTRONIC DEVICE

(71) Applicant: AAC Microtech (Changzhou) Co., Ltd., Changzhou City (CN)

(72) Inventors: Dong Lu, Changzhou (CN); Changliang Wang, Changzhou (CN); Lubin Mao, Changzhou (CN); Lijin Zhang, Changzhou (CN)

(21) Appl. No.: 19/333,370

(22) Filed: Sep. 19, 2025

Related U.S. Application Data
(63) Continuation of application No. PCT/CN2025/073533, filed on Jan. 21, 2025.

(51) Int. Cl. H01H 13/14; H01H 13/06

(52) U.S. Cl. CPC H01H 13/14; H01H 13/06; H01H 2215/052

(57) ABSTRACT

A button structure and an electronic device. The button structure includes a keycap, a sealing ring, a sensor, a metal connector and a piezoelectric single crystal assembly. A central axis of the sealing ring is perpendicular to the sensor, the sealing ring is fixed to a housing of the electronic device when the button structure is embedded in the housing of the electronic device, and the piezoelectric single crystal assembly is fixed to an inner side of the housing. The present disclosure can improve drop reliability of button structure and aesthetic perception after the button structure is mounted in the housing of the electronic device, the button structure can achieve various adaptive effects to various scenarios, and prompts and feedback which are more direct and are favorable for a muscle memory are provided for a user, and the button structure has a waterproof function.

### TECHNICAL FIELD

The present disclosure relates to the technical field of buttons and, in particular, to a button structure and an electronic device.

### BACKGROUND

A mechanical button is a control structure for achieving a control function by pressing a corresponding position, and is mainly applied to electronic devices, such as a mobile phone, a tablet, and a game machine.

In the related art, the mechanical button mainly includes a keycap and a metal dome, and has a control principle that displacement is realized by pressing a part of the keycap protruding out of a housing of the electronic device, and at this point, the displacement generated by the keycap can be transmitted to the metal dome to switch on a circuit to achieve a control effect, and correspondingly, a hand feeling of the mechanical button is realized by force feedback during deformation of the metal dome.

Although the mechanical button can provide the corresponding control function for the electronic device, the keycap of the mechanical button protrudes out of the housing of the electronic device, so that external integration of the mechanical button and the housing of the electronic device is influenced, thereby affecting the drop reliability of the mechanical button and the appearance of the housing of the electronic device. In addition, the mechanical button has a single effect, cannot achieve adaptive effects to various scenarios, and cannot provide prompts and feedback which are more direct and are favorable for a muscle memory for a user.

Therefore, it is desirable to provide a button structure and an electronic device to solve the above problems.

### SUMMARY

An objective of the present disclosure is to provide a button structure and an electronic device, so as to solve the problems that the drop reliability of a mechanical button and the appearance of a housing of an electronic device in the related art are influenced, adaptive effects to various scenarios cannot be achieved, and meanwhile, prompts and feedback which are more direct and are favorable for a muscle memory cannot be provided for a user.

In an aspect, the present disclosure provides a button structure mounted in an electronic device to implement touch feedback of the electronic device. The button structure includes a keycap, a sealing ring arranged around an outer periphery of the keycap, fixedly connected to the keycap and having elasticity, a sensor fixed to a back surface of a pressing surface of the keycap, a metal connector fixed to a side of the sensor away from the keycap, and a piezoelectric single crystal assembly fixed to a side of the metal connector away from the sensor, in which a central axis of the sealing ring is perpendicular to the sensor, the sealing ring is fixed to a housing of the electronic device when the button structure is embedded in the housing of the electronic device, and the piezoelectric single crystal assembly is fixed to an inner side of the housing.

As an improvement, the sealing ring is a silica gel ring, and the sealing ring has a rigidity value of 50-80 N/mm.

As an improvement, the sealing ring is fixedly connected to the keycap in an injection molding manner or a glue bonding manner.

As an improvement, the sensor is one of a piezoresistive sensor, a piezoelectric sensor, a capacitive sensor, and an ionizing sensor; and the sensor is fixedly connected to the keycap in a glue bonding manner or a laser welding manner.

As an improvement, the metal connector is a stainless steel connector; and the metal connector has a thickness of 0.3-0.5 mm.

As an improvement, the outer periphery of the keycap is recessed inward to form an annular mounting groove; the sealing ring includes an annular semi-ring-shaped ring body with an outward protruding cross section, an annular upper ring tongue extending upwards from an upper side of the ring body along an axial direction of the ring body, and an annular lower ring tongue extending downwards from a lower side of the ring body along the axial direction of the ring body, and the upper ring tongue and the lower ring tongue are closer to an outer side of the ring body compared with an inner side of the ring body; and the ring body is fixedly accommodated in the mounting groove, the upper ring tongue extends upwards along the outer periphery of the keycap to be flush with the pressing surface of the keycap, and the lower ring tongue extends downwards along the outer periphery of the keycap and is attached to the outer periphery of the keycap.

As an improvement, the piezoelectric single crystal assembly includes a metal substrate fixed on the side of the metal connector away from the sensor, and a piezoelectric ceramic sheet fixed on a side of the metal substrate away from the metal connector, a length of the metal substrate is greater than a length of the piezoelectric ceramic sheet, and parts of two ends of the metal substrate exceeding the piezoelectric ceramic sheet are respectively provided with mounting holes penetrating therethrough. The mounting holes are configured to fix the metal substrate to the housing through fixing members.

As an improvement, the metal substrate is a stainless steel substrate or a beryllium bronze substrate, and the metal substrate has a thickness of 0.1-0.5 mm.

As an improvement, the piezoelectric ceramic sheet has a piezoelectric stack structure formed by sequentially stacking 3-20 layers; and the piezoelectric ceramic sheet is fixedly connected to the metal substrate in a glue bonding manner or a laser welding manner.

In another aspect, the present disclosure provides an electronic device, including a housing and the above-mentioned button structure, in which a fixing hole is formed through a side of the housing, the piezoelectric single crystal assembly is mounted and fixed on an inner side of the housing, the pressing surface of the keycap and a corresponding outer side of the housing are located on a same horizontal plane, and the sealing ring is clamped and fixed between the keycap and a periphery of the fixing hole.

Compared with the related art, in the button structure according to the present disclosure, the sealing ring is arranged on the outer periphery of the keycap, the sealing ring is fixedly connected to the housing of the electronic device, and the piezoelectric single crystal assembly is fixed to the inner side of the housing of the electronic device, so that the button structure can be connected to and integrated with the housing of the electronic device through the elastic sealing ring, which is equivalent to the situation that the button structure can be completely integrated into the housing of the electronic device without requiring the keycap to protrude out of the housing of the electronic device. Meanwhile, the keycap can be provided with rigidity support when being pressed, and the keycap has the degree of freedom of local vibration. Equivalently, the disclosure improves the drop reliability of the button structure and the aesthetic perception after the button structure is mounted in the housing of the electronic device, the button structure can achieve the adaptive effects to various scenarios, and meanwhile, the prompts and feedback which are more direct and are favorable for the muscle memory are provided for the user. In addition, the sealing ring can play a waterproof role after being fixed on the housing of the electronic device.

### BRIEF DESCRIPTION OF DRAWINGS

To better describe the technical solutions in embodiments of the present disclosure, the following briefly describes the accompanying drawings required for the description of the embodiments. The accompanying drawings in the following description show merely some embodiments of the present disclosure, and a person of ordinary skill in the art may still derive other drawings from these accompanying drawings. In the drawings:

FIG. 1 is a schematic perspective structural diagram of a button structure according to a first embodiment of the present disclosure;

FIG. 2 is a schematic exploded structural diagram of the button structure according to the first embodiment of the present disclosure;

FIG. 3 is a sectional view taken along line A-A in FIG. 1;

FIG. 4 is an enlarged structural view of part B in FIG. 3;

FIG. 5 is a schematic perspective structural diagram of an electronic device according to a second embodiment of the present disclosure;

FIG. 6 is a schematic partial exploded structural diagram of the electronic device according to the second embodiment of the present disclosure;

FIG. 7 is a sectional view taken along line C-C in FIG. 5; and

FIG. 8 is an enlarged structural view of part D in FIG. 7.

In the drawings, 100: button structure; 1: keycap; 11: mounting groove; 2: sealing ring; 21: ring body; 22: upper ring tongue; 23: lower ring tongue; 3: sensor; 4: metal connector; 5: piezoelectric single crystal assembly; 51: metal substrate; 52: piezoelectric ceramic sheet.

200: electronic device; 201: housing; 202: fixing hole.

### DESCRIPTION OF EMBODIMENTS

The technical solutions in the embodiments of the present disclosure are clearly and completely described with reference to the accompanying drawings in the embodiments of the present disclosure, and apparently, the described embodiments are not all but only a part of the embodiments of the present disclosure. All other embodiments obtained by a person of ordinary skill in the art based on the embodiments of the present disclosure shall fall within the protection scope of the present disclosure.

### First embodiment

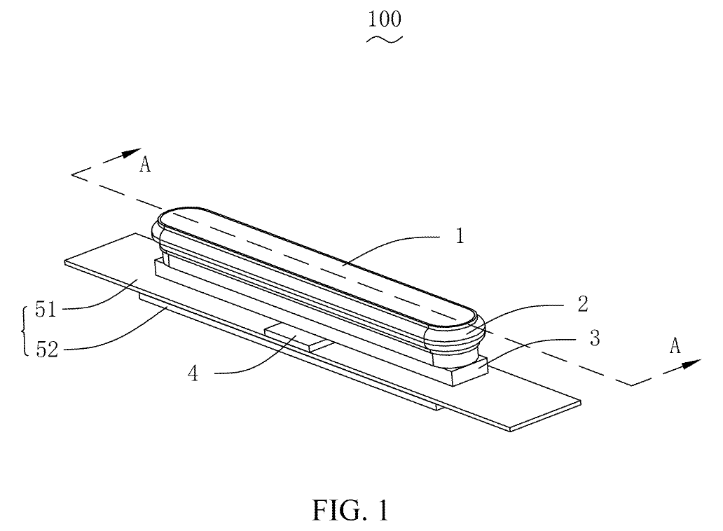

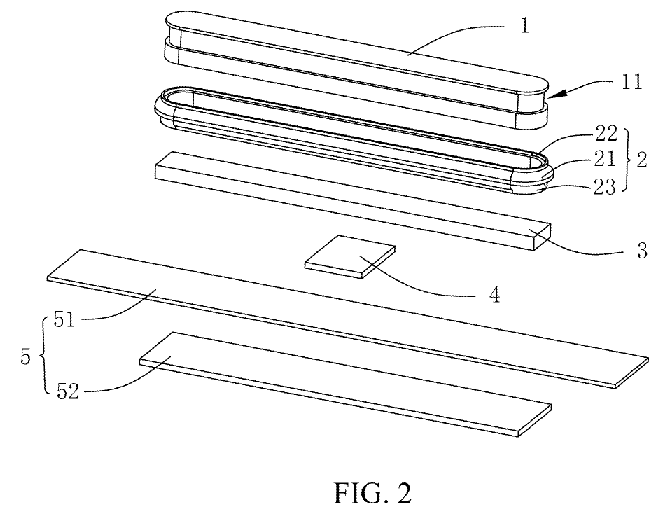

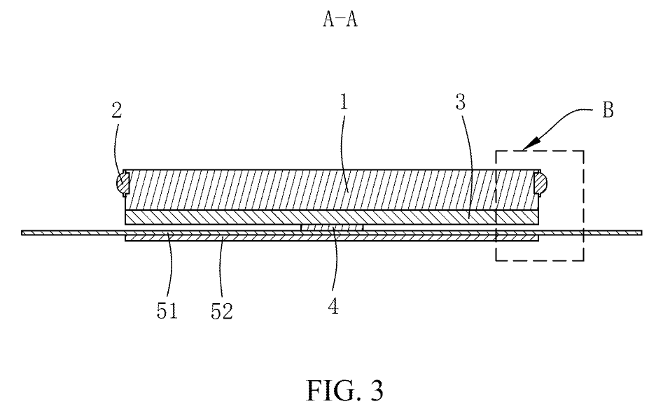

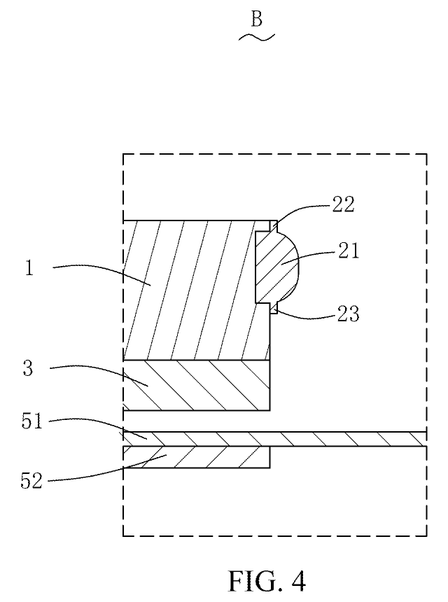

An embodiment of the present disclosure provides a button structure 100. As shown in FIG. 1 to FIG. 4, the button structure 100 includes a keycap 1, a sealing ring 2 arranged around an outer periphery of the keycap 1, fixedly connected to the keycap 1 and having elasticity, a sensor 3 fixed to a back surface of a pressing surface of the keycap 1, a metal connector 4 fixed to a side of the sensor 3 away from the keycap 1, and a piezoelectric single crystal assembly 5 fixed to a side of the metal connector 4 away from the sensor 3. A central axis of the sealing ring 2 is perpendicular to the sensor 3. The sealing ring 2 is fixed to a housing of an electronic device when the button structure 100 is embedded in the housing of the electronic device. The piezoelectric single crystal assembly 5 is fixed to an inner side of the housing.

The button structure 100 is mounted on the electronic device to implement touch feedback of the electronic device. When the button structure 100 needs to be mounted on the electronic device, the piezoelectric single crystal assembly 5 is fixed on the inner side of the housing, the sealing ring 2 is clamped and fixed between the keycap 1 and the housing, and meanwhile, the pressing surface of the keycap 1 is also located on the same horizontal plane as the corresponding outer side of the housing, and if the outer side of the housing is an arc surface or an irregular surface, a side of the keycap 1 away from the sensor 3 is matched with the outer side surface of the housing.

The pressing surface of the keycap 1 is a side of the keycap 1 away from the sensor 3, and the back surface of the pressing surface of the keycap 1 is a side of the keycap 1 adjacent to the sensor 3.

The outer periphery of the keycap 1 is provided with a mounting groove 11 formed by recessing inward. The sealing ring 2 includes an annular semi-ring-shaped ring body 21 with an outward protruding cross section, an annular upper ring tongue 22 extending upwards from an upper side of the ring body 21 along an axial direction of the ring body, and an annular lower ring tongue 23 extending downwards from a lower side of the ring body 21 along the axial direction of the ring body. The upper ring tongue 22 and the lower ring tongue 23 are closer to an outer side of the ring body 21 compared with an inner side of the ring body 21. The ring body 21 is fixedly accommodated in the mounting groove 11, the upper ring tongue 22 extends upwards along the outer periphery of the keycap 1 to be flush with the pressing surface of the keycap 1. The lower ring tongue 23 extends downwards along the outer periphery of the keycap 1 and is attached to the outer periphery of the keycap 1. Such a design can improve the steadiness between the sealing ring 2 and the keycap 1, and facilitate sealed and stable fixed connection formed between the sealing ring 2 and the housing of the electronic device.

The sealing ring 2 is a silica gel ring. It can be understood that, according to actual requirements, the sealing ring 2 can be a rubber ring, a plastic ring, etc.

A rigidity value of the sealing ring 2 is 50-80 N/mm. It can be understood that, the rigidity value of the sealing ring 2 may be properly reduced or increased according to actual requirements.

The sealing ring 2 is fixedly connected to the keycap 1 in an injection molding manner or a glue bonding manner. When the sealing ring 2 is fixedly connected to the keycap 1 in the injection molding manner, the sealing ring 2 and the keycap 1 are integrally formed.

The sensor 3 is any one of a piezoresistive sensor, a piezoelectric sensor, a capacitive sensor, and an ionizing sensor.

The sensor 3 is fixedly connected to the keycap 1 in a glue bonding manner or a laser welding manner.

The metal connector 4 is a stainless steel connector, and the metal connector 4 has a sheet structure and can also be called a soldering lug. It can be understood that, the metal connector 4 can be made of other alloy materials according to actual requirements, such as a copper sheet.

A thickness of the metal connector 4 is 0.3-0.5 mm. It can be understood that, the thickness of the metal connector 4 may be properly reduced or increased according to actual requirements.

The metal connector 4 is fixedly connected to the sensor 3 and the piezoelectric single crystal assembly 5 respectively in a glue bonding manner or a laser welding manner.

The piezoelectric single crystal assembly 5 includes a metal substrate 51 fixed to the side of the metal connector 4 away from the sensor 3, and a piezoelectric ceramic sheet 52 fixed to a side of the metal substrate 51 away from the metal connector 4.

A length of the metal substrate 51 is greater than a length of the piezoelectric ceramic sheet 52, and parts of two ends of the metal substrate 51 exceeding the piezoelectric ceramic sheet 52 are respectively provided with mounting holes (not shown) penetrating therethrough. The mounting holes are configured to fix the metal substrate 51 to the housing through fixing members (not shown) which may be rivets, screws, bolts, or the like.

The metal substrate 51 is a stainless steel substrate or a beryllium bronze substrate. It can be understood that, according to actual requirements, the metal substrate 51 only needs to be made of metal, and is not limited to stainless steel or beryllium bronze.

A thickness of the metal substrate 51 is 0.1-0.5 mm. It can be understood that, the thickness of the metal substrate 51 may be properly reduced or increased according to actual requirements.

The piezoelectric ceramic sheet 52 has a piezoelectric stack structure formed by sequentially stacking 3-20 layers. The piezoelectric ceramic sheet 52 is fixedly connected to the metal substrate 51 in a glue bonding manner or a laser welding manner.

Compared with the related art, in the button structure 100 according to the present embodiment, the sealing ring 2 is arranged on the outer periphery of the keycap 1, the sealing ring 2 is fixedly connected to the housing of the electronic device, and the piezoelectric single crystal assembly 5 is fixed to the inner side of the housing of the electronic device, so that the button structure 100 can be connected to and integrated with the housing of the electronic device through the elastic sealing ring 2, which is equivalent to the situation that the button structure 100 can be completely integrated into the housing of the electronic device without requiring the keycap 1 to protrude out of the housing of the electronic device. Meanwhile, the keycap 1 can be provided with rigidity support when being pressed, and the keycap 1 has the degree of freedom of local vibration. Equivalently, the disclosure improves the drop reliability of the button structure 100 and the aesthetic perception after the button structure is mounted in the housing of the electronic device, the button structure 100 can achieve the adaptive effects to various scenarios, and meanwhile, prompts and feedback which are more direct and are favorable for the muscle memory are provided for the user, that is, abundant local vibration feedback can be brought to the user; in addition, the sealing ring 2 can play a waterproof role after being fixed on the housing of the electronic device.

### Second embodiment

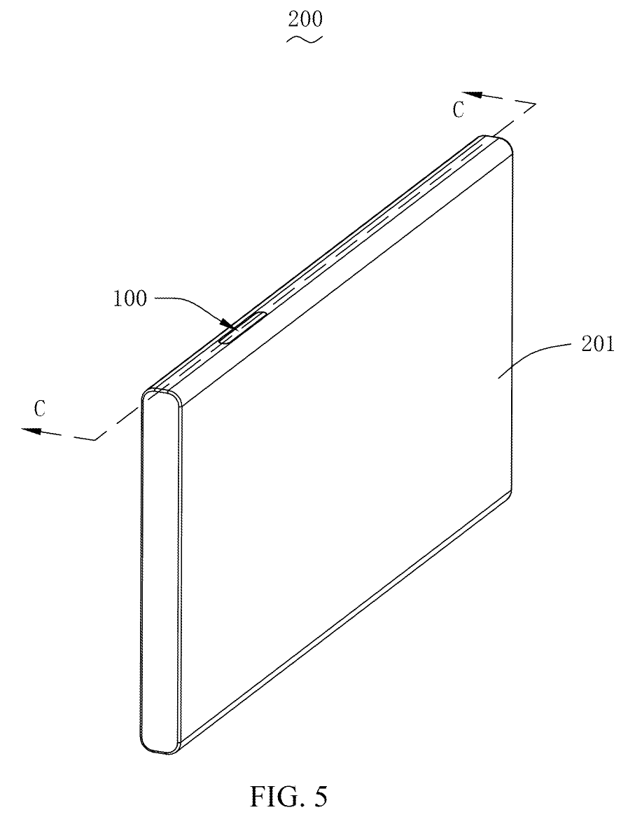

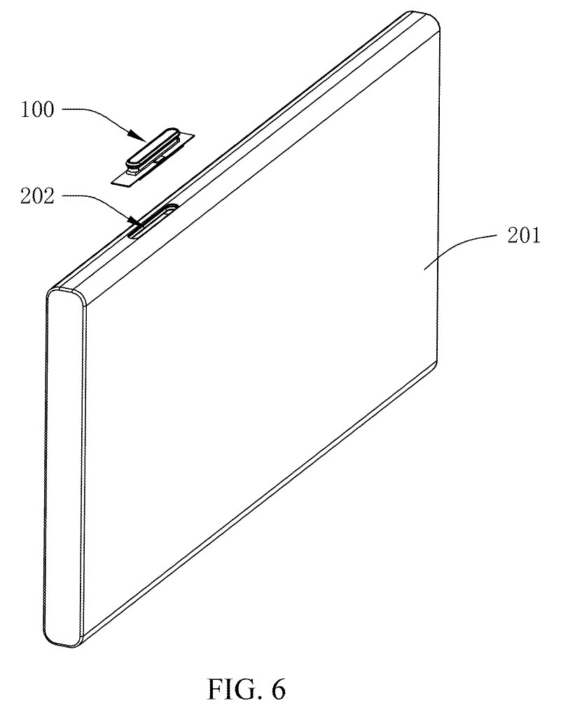

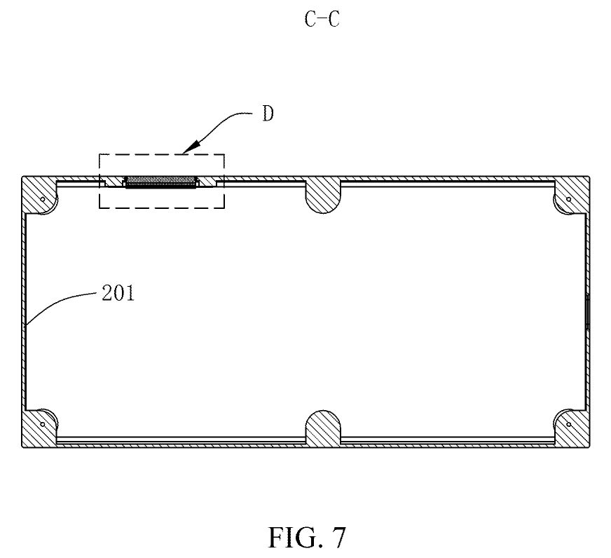

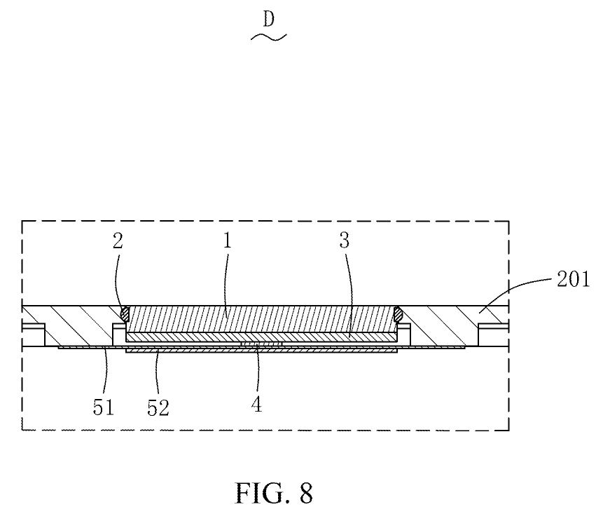

An embodiment of the present disclosure provides an electronic device 200. As shown in FIG. 5 to FIG. 8, the electronic device 200 includes a housing 201 and the button structure 100 according to the first embodiment. A fixing hole 202 is formed through a side of the housing 201. The piezoelectric single crystal assembly 5 is mounted and fixed on an inner side of the housing 201. The pressing surface of the keycap 1 and a corresponding outer side of the housing 201 are located on the same horizontal plane. The sealing ring 2 is clamped between the keycap 1 and a periphery of the fixing hole 202.

The electronic device 200 may be a mobile phone, a tablet, a game machine, or the like.

The piezoelectric single crystal assembly 5 is fixed to an inner periphery of the housing 201 by allowing the fixing member to pass through the mounting hole in the metal substrate 51.

Since the electronic device 200 according to this embodiment includes the button structure 100 according to the first embodiment, the technical effect achieved by the button structure 100 according to the first embodiment can also be achieved, and details are not elaborated herein.

The above description is only embodiments of the present disclosure, and it should be noted that improvements can be made by those of ordinary skill in the art without departing from the concept of the present disclosure, and all fall within the protection scope of the present disclosure.

What is claimed is:

1. A button structure, mounted in an electronic device to implement touch feedback of the electronic device, comprising:
a keycap;
a sealing ring arranged around an outer periphery of the keycap, fixedly connected to the keycap and having elasticity;
a sensor fixed to a back surface of a pressing surface of the keycap;
a metal connector fixed to a side of the sensor away from the keycap; and
a piezoelectric single crystal assembly fixed to a side of the metal connector away from the sensor,
wherein a central axis of the sealing ring is perpendicular to the sensor, the sealing ring is fixed to a housing of the electronic device when the button structure is embedded in the housing of the electronic device, and the piezoelectric single crystal assembly is fixed to an inner side of the housing.

2. The button structure as described in claim 1, wherein the sealing ring is a silica gel ring, and the sealing ring has a rigidity value of 50-80 N/mm.

3. The button structure as described in claim 2, wherein the sealing ring is fixedly connected to the keycap in an injection molding manner or a glue bonding manner.

4. The button structure as described in claim 1, wherein the sensor is one of a piezoresistive sensor, a piezoelectric sensor, a capacitive sensor, and an ionizing sensor; and the sensor is fixedly connected to the keycap in a glue bonding manner or a laser welding manner.

5. The button structure as described in claim 1, wherein the metal connector is a stainless steel connector; and the metal connector has a thickness of 0.3-0.5 mm.

6. The button structure as described in claim 1, wherein the outer periphery of the keycap is recessed inward to form an annular mounting groove;
wherein the sealing ring comprises an annular semi-ring-shaped ring body with an outward protruding cross section, an annular upper ring tongue extending upwards from an upper side of the ring body along an axial direction of the ring body, and an annular lower ring tongue extending downwards from a lower side of the ring body along the axial direction of the ring body, and the upper ring tongue and the lower ring tongue are closer to an outer side of the ring body compared with an inner side of the ring body; and
wherein the ring body is fixedly accommodated in the mounting groove, the upper ring tongue extends upwards along the outer periphery of the keycap to be flush with the pressing surface of the keycap, and the lower ring tongue extends downwards along the outer periphery of the keycap and is attached to the outer periphery of the keycap.

7. The button structure as described in claim 1, wherein the piezoelectric single crystal assembly comprises a metal substrate fixed on the side of the metal connector away from the sensor, and a piezoelectric ceramic sheet fixed on a side of the metal substrate away from the metal connector, a length of the metal substrate is greater than a length of the piezoelectric ceramic sheet, and parts of two ends of the metal substrate exceeding the piezoelectric ceramic sheet are respectively provided with mounting holes penetrating therethrough; and
wherein the mounting holes are configured to fix the metal substrate to the housing through fixing members.

8. The button structure as described in claim 7, wherein the metal substrate is a stainless steel substrate or a beryllium bronze substrate, and the metal substrate has a thickness of 0.1-0.5 mm.

9. The button structure as described in claim 7, wherein the piezoelectric ceramic sheet has a piezoelectric stack structure formed by sequentially stacking 3-20 layers; and the piezoelectric ceramic sheet is fixedly connected to the metal substrate in a glue bonding manner or a laser welding manner.

10. An electronic device, comprising a housing and a button structure according to claim 1, wherein a fixing hole is formed through a side of the housing, the piezoelectric single crystal assembly is mounted and fixed on an inner side of the housing, the pressing surface of the keycap and a corresponding outer side of the housing are located on a same horizontal plane, and the sealing ring is clamped and fixed between the keycap and a periphery of the fixing hole.
